(19) United States
(12) Patent Application Publication
(10) Pub. No.: US 2014/0317615 A1
(43) Pub. Date: Oct. 23, 2014

(54) Systems and Methods for Installing Applications

(71) Applicant: Tencent Technologies (Shenzhen) Company Limited, Shenzhen (CN)

(72) Inventors: Liang Ma, Shenzhen (CN); Zhiqiang He, Shenzhen (CN); Chunhua Luo, Shenzhen (CN); Fajiang He, Shenzhen (CN); Jie Zeng, Shenzhen (CN)

(73) Assignee: Tencent Technologies (Shenzhen) Company Limited, Shenzhen (CN)

(21) Appl. No.: 14/165,784

(22) Filed: Jan. 28, 2014

Related U.S. Application Data
(63) Continuation of application No. PCT/CN2013/086649, filed on Nov. 6, 2013.

(30) Foreign Application Priority Data
Apr. 19, 2013 (CN) 201310137161.0

(51) Int. Cl. G06F 9/445

(52) U.S. Cl. CPC G06F 8/61
USPC 717/176

(57) ABSTRACT

Systems and methods are provided for installing an application on a mobile terminal. For example, one or more first drivers are obtained based on at least information associated with identification of a first mobile terminal; the first drivers are installed on an information-processing device; a network connection between the information-processing device and the first mobile terminal is established based on at least information associated with the first drivers; one or more local parameters of the first mobile terminal are queried through the network connection; an application-installation package is obtained based on at least information associated with the local parameters; and an application is installed on the first mobile terminal using the network connection based on at least information associated with the application-installation package.

### CROSS-REFERENCES TO RELATED APPLICATIONS

This application claims priority to Chinese Patent Application No. 201310137161.0, filed Apr. 19, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to application installation. But it would be recognized that the invention has a much broader range of applicability.

The conventional procedures for installing applications in a mobile phone are often as follows: downloading applications to the mobile phone through a mobile network and then install the applications in the mobile phone directly. As the development of smart phones, the sizes of mobile phone applications, especially mobile game installation packages, continue to increase. Therefore, the conventional application-installation technology has some disadvantages, such as a low downloading speed and a long installation time.

Hence it is highly desirable to improve the techniques for installing applications.

### BRIEF SUMMARY OF THE INVENTION

According to one embodiment, a method is provided for installing an application on a mobile terminal. For example, one or more first drivers are obtained based on at least information associated with identification of a first mobile terminal; the first drivers are installed on an information-processing device; a network connection between the information-processing device and the first mobile terminal is established based on at least information associated with the first drivers; one or more local parameters of the first mobile terminal are queried through the network connection; an application-installation package is obtained based on at least information associated with the local parameters; and an application is installed on the first mobile terminal using the network connection based on at least information associated with the application-installation package.

According to another embodiment, a system for installing an application on a mobile terminal includes: a driver-obtaining module, a driver-installation module, a network-connection module, a parameter-query module, an application-obtaining module, and an application-installation module. The driver-obtaining module is configured to obtain one or more first drivers based on at least information associated with identification of a first mobile terminal. The driver-installation module is configured to install the first drivers on an information-processing device. The network-connection module is configured to establish a network connection between the information-processing device and the first mobile terminal based on at least information associated with the first drivers. The parameter-query module is configured to query one or more local parameters of the first mobile terminal through the network connection. The application-obtaining module is configured to obtain an application-installation package based on at least information associated with the local parameters. The application-installation module is configured to install an application on the first mobile terminal using the network connection based on at least information associated with the application-installation package.

According to yet another embodiment, a non-transitory computer readable storage medium comprises programming instructions for installing an application on a mobile terminal. The programming instructions are configured to cause one or more data processors to execute certain operations. For example, one or more first drivers are obtained based on at least information associated with identification of a first mobile terminal; the first drivers are installed on an information-processing device; a network connection between the information-processing device and the first mobile terminal is established based on at least information associated with the first drivers; one or more local parameters of the first mobile terminal are queried through the network connection; an application-installation package is obtained based on at least information associated with the local parameters; and an application is installed on the first mobile terminal using the network connection based on at least information associated with the application-installation package.

For example, the systems and methods described herein are configured to automatically install one or more drivers for a mobile terminal upon reception of a user request for installing an application and enable automatic installation of the application through the drivers, so as to avoid downloading the application from a mobile network and avoid manual installation of the drivers by the user in order to save the installation time.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a running environment of a system for installing applications in a mobile terminal according to one embodiment of the present invention.

FIG. 2 is a simplified diagram showing the application-installation system as shown in FIG. 1 according to one embodiment of the present invention.

FIG. 3 is a simplified diagram showing interaction between the application-installation system as shown in FIG. 2 and a cloud server and a mobile terminal as shown in FIG. 1 according to one embodiment of the present invention.

FIG. 4 is a simplified diagram showing a debug bridge driver run on an information-processing device as shown in FIG. 1 according to one embodiment of the present invention.

FIG. 5 is a simplified diagram showing the system as shown in FIG. 1 according to another embodiment of the present invention.

FIG. 6 is a simplified diagram showing a method for installing applications in a mobile terminal according to one embodiment of the present invention.

FIG. 7 is a simplified diagram showing the method as shown in FIG. 6 according to another embodiment of the present invention.

### DETAILED DESCRIPTION OF THE INVENTION

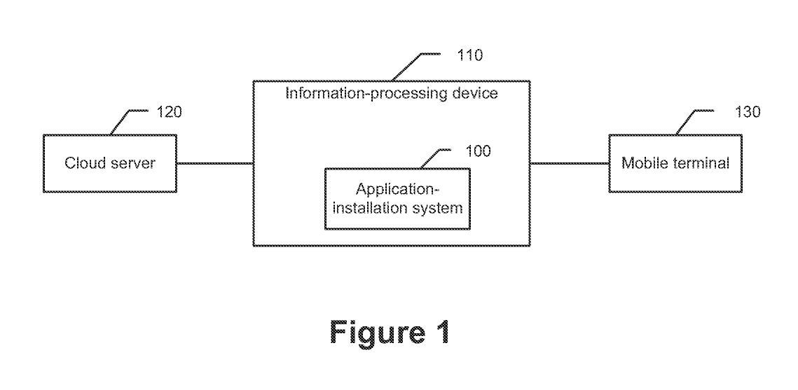

FIG. 1 is a simplified diagram showing a running environment of a system for installing applications in a mobile terminal according to one embodiment of the present invention. This diagram is merely an example, which should not unduly limit the scope of the claims. One of ordinary skill in the art would recognize many variations, alternatives, and modifications.

According to one embodiment, a system 100 for installing applications in a mobile terminal (hereinafter referred to as the “application-installation system 100”) runs on an information-processing device 110. For example, the information-processing device 110 includes an electronic device which has an operating system installed and can run different applications, such as desktop computers, laptop computers, smart phones, tablet computers, and personal digital assistants. As shown in FIG. 1, the information-processing device 110 is connected to a cloud server 120 through the Internet, and also connected to a mobile terminal 130 through a data interface (e.g., a Universal Serial Bus interface), in some embodiments. For example, the cloud server 120 returns corresponding information or resources in response to a request from the information-processing device 110. In certain embodiments, the device 110 is connected to multiple cloud servers, and/or connected to multiple mobile terminals.

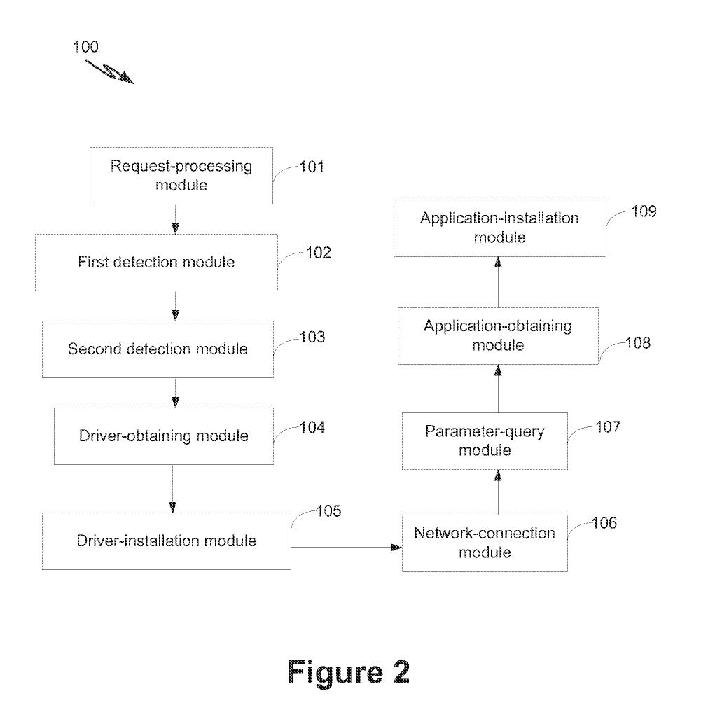

FIG. 2 is a simplified diagram showing the application-installation system 100 according to one embodiment of the present invention. This diagram is merely an example, which should not unduly limit the scope of the claims. One of ordinary skill in the art would recognize many variations, alternatives, and modifications. The application-installation system 100 includes: a request-processing module 101, a first detection module 102, a second detection module 103, a driver-obtaining module 104, a driver-installation module 105, a network-connection module 106, a parameter-query module 107, an application-obtaining module 108, and an application-installation module 109.

According to one embodiment, the request-processing module 101 receives an application-installation request entered by a user. For example, a user browses a web page of an application store through a browser run on the information-processing device 110. As an example, the request-processing module 101 is implemented based on script codes (for example, JavaScript) embedded in the web page. In another example, when the user selects an application on the web page, it triggers a request for installing the application. The request-processing module 101 receives the request for installing the application, and triggers another module, for example, the first detection module 102 to perform subsequent operations.

According to another embodiment, the first detection module 102 detects whether a mobile terminal 130 is connected to the information-processing device 110 after the request-processing module 101 receives a request for installing an application. As an example, herein the connection means a connection implemented through a specific hardware interface, e.g., a USB interface. For example, the first detection module 102 traverses all equipment connected to the USB interfaces of the information-processing device 110, reads equipment identification, such as a Vender ID (VID) or a Product ID (PID), and identifies whether particular equipment is a mobile terminal of a designated type based on the equipment identification. The designated type corresponds to a mobile terminal such as a smart phone or a tablet computer which runs a required operating system and can have the application installed, in some embodiments.

According to yet another embodiment, the second detection module 103 detects whether one or more drivers are installed on the mobile terminal 130 if the first detection module 102 detects the mobile terminal 130 is connected to the information-processing device 110. For example, the driver-obtaining module 104 is used to obtain corresponding drivers for the mobile terminal 130 according to the identification of the mobile terminal 130 when the second detection module 103 detects that the drivers are not installed on the mobile terminal 130. In another example, the drivers are stored in the cloud server 120. In yet another example, the driver-obtaining module 104 sends the identification of the mobile terminal 130 to the cloud server 120 to request for the corresponding drivers. In yet another example, upon receiving the request, the cloud server 120 retrieves the corresponding drivers according to the identification and then returns the drivers to the driver-obtaining module 104. As an example, the cloud server 120 returns download addresses of the drivers, and then the driver-obtaining module 104 sends a request to the download addresses. As another example, the drivers are directly stored in the information-processing device 110.

In one embodiment, the driver-installation module 105 is used to install the drivers obtained by the driver-obtaining module 104 on the information-processing device 110. For example, the drivers include compressed files, and the driver-installation module 105 performs decompression of the compressed files. As an example, a driver includes the following files: (1) one or more configuration files (inf files), (2) one or more resource files, e.g., real-mode equipment driver files (sys files), dynamic link library files (dll files), and (3) one or more signature files (cat files). As another example, a driver contains other suitable files. Only driver components needed for a particular application are installed for installing the application, in some embodiments.

In another embodiment, a debug-bridge driver is installed for a mobile phone operating system. For example, the program files corresponding to the debug-bridge driver have the following characteristics:

(1) The names of the inf files may contain “android usb” or “adb.” Different vendors may use different names.
(2) Resource files may include “androidusb.sys” or certain dll files such as “WdfCoInstaller01005.dll.”
(3) The inf files of some drivers contain the “i386” and “amd64” folders to enable installation of two systems. For example, the “i386” folder is provided for installation of a 32-bit system, and the “amd64” folder is provided for installation of a 64-bit system.
(4) The drivers of some vendors may provide one or more signature files. A red alert shows up if the driver to be installed does not have a signature file. Some drivers cannot be installed on certain operating systems, for example, Windows 7, without the signature files.
(5) A part of an inf file may contain:
CatalogFile.NTx86=androidwinusb86.cat (for a 32-bit system)
CatalogFile.NTamd64=androidwinusba64.cat (for a 64-bit system)
which indicate the names of the required signature files. A user can determine whether it is a 32-bit driver or a 64-bit driver through the names of the signature files, in some embodiments. For example, the inf file includes both names of the signature files, both the 32-bit system and the 64-bit system use the same inf file.
(6) An inf file usually contains multiple records in the following format:
% CompositeAdbInterface %=USB_Install. USB\VID_{—}0BB4&PID_{—}0C02&MI_{—}01
Here, VID_{—}0BB4 indicates that a vendor ID of the equipment is 0BB4, and PID_{—}0C02 indicates that a product ID of the equipment is 0C02. For example, if hardware information of the mobile terminal 130 is consistent with the above information, the application can be installed on the mobile terminal 130 using this driver.
(7) An inf file may also contain the following records:

[SourceDisksNames]-----the resource files required for application
installation
1=%DISK_NAME%...\i386 ------1 indicates the path of the resource files
for the 32-bit system is\i386
2=%DISK_NAME%...\amd64-----2 indicates the path of the resource files
for the 64-bit system is\amd64
[SourceDisksFiles.x86]
WinUSBCoInstaller2.dll = 1
WdfCoInstaller01009.dll = 1
[SourceDisksFiles.amd64]
WinUSBCoInstaller2.dll = 2
WdfCoInstaller01009.dll = 2

As an example, resource files of some drivers are not specific for a 32-bit system or a 64-bit system, and may contain multiple [SourceDisksFiles] with a following format.

[SourceDisksFiles]
androidusb.sys = 1
[SourceDisksFiles]
wdfcoinstaller01005.dll=1

In certain embodiments, all files in SourceDisksFile are collected.

In some embodiments, driver files are collected as described above. For example, an installation service of an operating system is invoked to install the drivers.

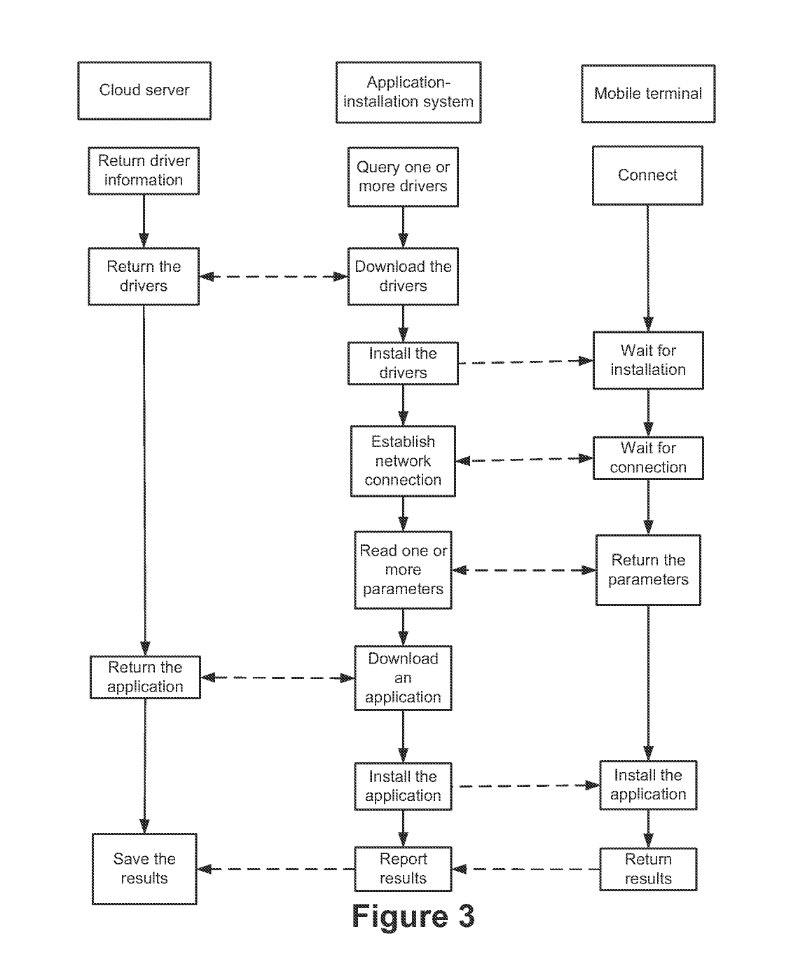

FIG. 3 is a simplified diagram showing interaction between the application-installation system as shown in FIG. 2 and a cloud server and a mobile terminal as shown in FIG. 1 according to one embodiment of the present invention. This diagram is merely an example, which should not unduly limit the scope of the claims. One of ordinary skill in the art would recognize many variations, alternatives, and modifications.

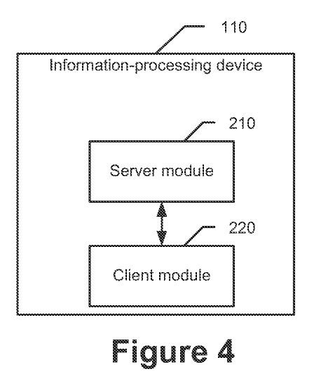

FIG. 4 is a simplified diagram showing a debug bridge driver run on an information-processing device as shown in FIG. 1 according to one embodiment of the present invention. This diagram is merely an example, which should not unduly limit the scope of the claims. One of ordinary skill in the art would recognize many variations, alternatives, and modifications. The information-processing device 110 includes a server module 210 and a client module 220.

According to one embodiment, the server module 210 is an interface to interact with the mobile terminal 130 which receives requests from the client module 220. For example, some requests are processed directly by the server module 210 without interaction with the mobile terminal 130, and other requests are processed by the server module 210 with interaction with the mobile terminal 130, e.g., through an interaction process (adbd) run on the mobile terminal 130. Thus, the server module 210 virtually works as a switch, according to certain embodiments.

According to another embodiment, the client module 220 is enabled by a user to implement functions requested by the user. For example, the user includes an operator. In another example, the user includes process modules, such as, the network-connection module 106, the parameter-query module 107, and the application-installation module 109.

According to yet another embodiment, the network-connection module 106 establishes a network connection with the mobile terminal 130. For example, the server module 210 establishes a network connection with the interaction process run on the mobile terminal 130. As an example, the network connection includes a TCP connection. According to certain debug-bridge protocols, assuming the mobile terminal 130 has an IP address of 127.0.0.1, a TCP connection is established for the mobile terminal 130 through a predefined port, in some embodiments.

In one embodiment, handshake packets are sent and/or received in a polling mode to determine whether the connection between the information-processing device 110 and the mobile terminal 130 is successfully established. For example, according to an agreed-upon interaction, the server module 220 sends a packet and waits for a response from the client module 210. As an example, if the server module 220 receives a response packet from the client module 210, the connection is established, and if the server module 220 receives a timeout message, the connection is not established. In another example, if the connection is not established, a Socket is re-established for establishing the connection, and the handshake packets are sent and/or received again.

In another embodiment, the parameter-query module 107 queries local parameters of the mobile terminal through the network connection. For example, query interfaces of different parameters are opened according to one or more predefined adbd protocols. In another example, the parameter-query module 107 queries the parameters through these interfaces, e.g., a screen resolution parameter or a version parameter of the operating system.

In yet another embodiment, the application-obtaining module 108 obtains the corresponding application-installation package according to the local parameters. For example, the application-obtaining module 108 submits the parameters queried by the parameter-query module 107 to the cloud server 120. Accordingly, the cloud server 120 obtains the corresponding application resource pack according to the parameters and then returns the resource pack to the application-obtaining module 108, in some embodiments. For example, the application-installation module 109 installs the application in the mobile terminal 130 by using the network connection and the application-installation package. In another example, the installation process is executed through an adb install command. In yet another example, the installation package is decompressed to the storage card of the mobile terminal 130 through an adb poll command if needed. In yet another example, the application-installation module 109 uploads the installation results to the cloud server 120 to facilitate calculation of background statistics.

In certain embodiments, modules of the application-installation system 100 (except the request-processing module 101) are packaged into a plug-in (e.g., an ActiveX plug-in) which is stored in the cloud server 120. For example, when a web page is loaded, the browser automatically loads the plug-in from the cloud server 120 according to tags in the web page. In another example, upon completion of loading the web page, the request-processing module 101 invokes the first detection module 102 in the plug-in.

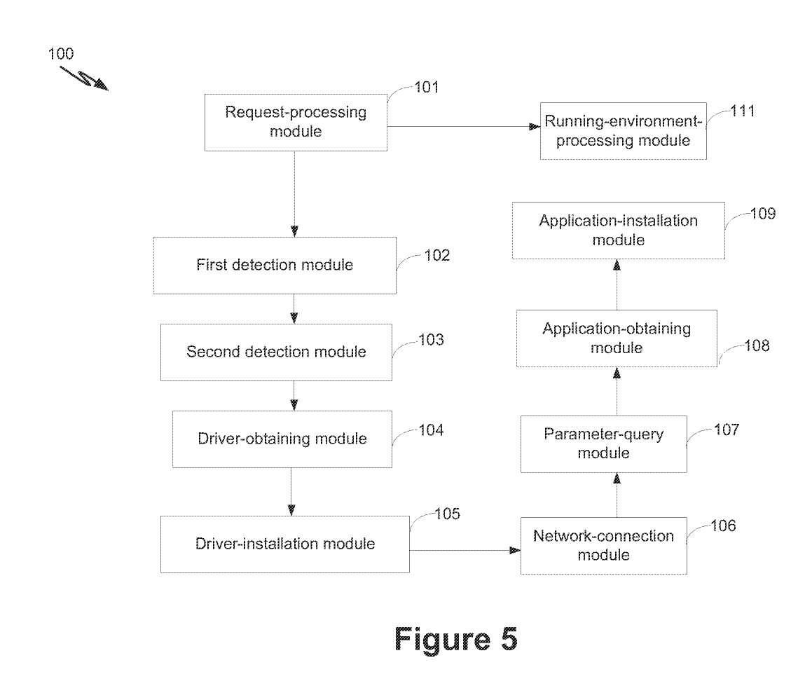

FIG. 5 is a simplified diagram showing the application-installation system 100 according to another embodiment of the present invention. This diagram is merely an example, which should not unduly limit the scope of the claims. One of ordinary skill in the art would recognize many variations, alternatives, and modifications.

According to one embodiment, the application-installation system 100 further includes a running-environment-processing module 111 configured to determine whether the application depends on one or more running environments. For example, the running environments include some basic applications that provide fundamental and generic services, and the application to be installed depends on the interfaces provided by the basic applications. As an example, the running-environment-processing module 111 is further configured to: in response to the application depending on the one or more running environments, detect whether the one or more running environments are installed on the mobile terminal. In another example, if the application does not depend on the one or more running environments, the application can executed independently, and the installation process of the application continues to be executed.

According to another embodiment, the running-environment-processing module 111 is further configured to: in response to the one or more running environments are not installed on the mobile terminal, request the one or more running environments from the cloud server 120. For example, the running-environment-processing module 111 is further configured to obtain the one or more running environments from the cloud server 120 and install the one or more running environments on the mobile terminal 130, so as to ensure the application to be installed and executed. The running environments correspond to one or more applications, and the installation process of the running environments is similar to the installation process of the application described above.

According to yet another embodiment, whether an application depends on one or more running environments can be recorded and transferred by using certain status flags. For example, when a user selects an application on a web page, a request for installing the application is triggered, and may contain one or more status flags. In another example, the request-processing module 101 receives the status flags, and then the request-processing module 101 transfers such status flags to the running-environment-processing module 111. In yet another example, the running-environment-processing module 111 determines whether the application depends on the one or more running environments based on information associated with the status flags. In some embodiments, the application-installation system 100 as shown in FIG. 5 enables automatic installation and processing of an application dependent on one or more running environments so as to further shorten the installation time.

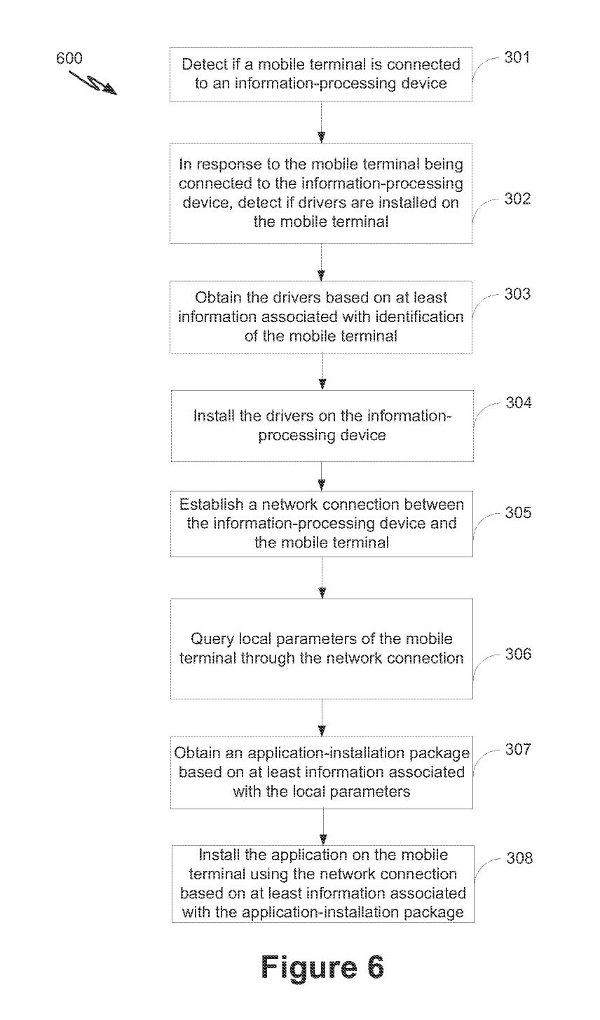

FIG. 6 is a simplified diagram showing a method for installing applications in a mobile terminal according to one embodiment of the present invention. This diagram is merely an example, which should not unduly limit the scope of the claims. One of ordinary skill in the art would recognize many variations, alternatives, and modifications. The method 600 includes at least the process 301 for detecting if a mobile terminal is connected to an information-processing device, the process 302 for detecting if drivers are installed on the mobile terminal in response to the mobile terminal being connected to the information-processing device, the process 303 for obtaining the drivers, and the process 304 for installing the drivers on the information-processing device. The method 600 further includes the process 305 for establishing a network connection between the information-processing device and the mobile terminal, the process 306 for querying local parameters of the mobile terminal through the network connection, the process 307 for obtaining an application-installation package, and the process 308 for installing the application on the mobile terminal using the network connection.

According to one embodiment, the method 600 as shown in FIG. 6 is executed by the information-processing device 110. For example, a user can browse web pages associated with an application store through a browser run on the information-processing device 110. As an example, when the user selects an application on the web page, a request for installing the application is triggered, and then the application is installed on the mobile terminal 130 using the method 600.

According to another embodiment, during the process 301, whether a mobile terminal (e.g., the terminal 130) is connected to the information-processing device 110 is detected upon reception of a request for installing an application. For example, the process 301 includes: traversing all equipment connected to the USB interfaces of the information-processing device 110, reading equipment identification, such as a Vender ID (VID) or a Product ID (PID), and identifying whether particular equipment is a mobile terminal of a designated type based on the equipment identification. The designated type corresponds to a mobile terminal such as a smart phone or a tablet computer which runs a required operating system and can have the application installed, in some embodiments. In another example, during the process 302, whether drivers are installed on the mobile terminal is detected in response to the mobile terminal being connected to the information-processing device 110. In yet another example, whether the drivers are installed is detected by reading the driver information from the operating system.

According to yet another embodiment, during the process 303, the drivers are obtained based on at least information associated with identification of the mobile terminal 130 if the drivers are not installed on the mobile terminal 130. For example, the drivers are stored in the cloud server 120. In another example, the process 303 includes: sending the identification of the mobile terminal 130 to the cloud server 120 to request the drivers. In yet another example, upon receiving the request, the cloud server 120 retrieves the corresponding drivers according to the identification and then returns the drivers. Accordingly, the process 303 further includes: receiving the drivers from the cloud server 120.

In one embodiment, during the process 304, the drivers are installed on the information-processing device 110. For example, the drivers include compressed files which are decompressed before installation. In another example, during the process 305, a network connection is established with the mobile terminal 130 based on at least information associated with the drivers. In yet another example, after the drivers are installed, the network connection is established with the mobile terminal 130 through the drivers. As an example, the network connection includes a TCP connection. According to certain debug-bridge protocols, assuming the mobile terminal 130 has an IP address of 127.0.0.1, a TCP connection is established for the mobile terminal 130 through a predefined port, in some embodiments.

In another embodiment, during the process 306, one or more local parameters of the mobile terminal are queried through the network connection. For example, after the network connection is successfully established, the parameters required by the application are queried on the mobile terminal 130 through the network connection, e.g., a screen resolution parameter or a version parameter of the operating system. In another example, during the process 307, the corresponding application-installation package is obtained based on the local parameters. In yet another example, the queried parameters are submitted to the cloud server 120. Accordingly, the cloud server 120 obtains the corresponding application resource pack according to the parameters and then returns the resource pack, in some embodiments.

In yet another embodiment, during the process 308, the application is installed on the mobile terminal through the network connection using the application-installation package. For example, after the application resource pack is obtained, installation operations are performed. As an example, the installation process is executed through an adb install command. As another example, the installation package is decompressed to the storage card of the mobile terminal 130 through an adb poll command if needed. As yet another example, the installation results are uploaded to the cloud server 120 to facilitate calculation of background statistics.

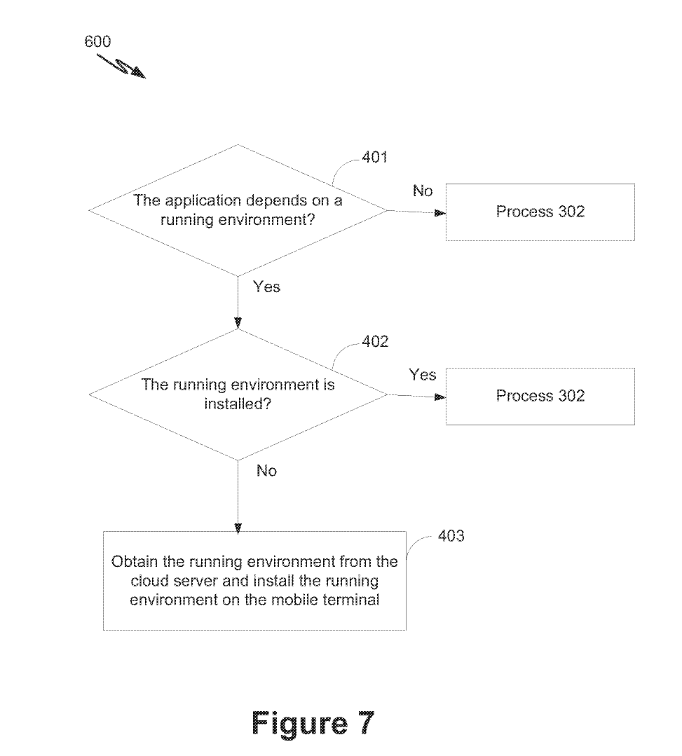

FIG. 7 is a simplified diagram showing certain processes of the method 600 according to another embodiment of the present invention. This diagram is merely an example, which should not unduly limit the scope of the claims. One of ordinary skill in the art would recognize many variations, alternatives, and modifications. The method 600 further includes at least the process 401 for determining whether the application depends on one or more running environments, the process 402 for detecting whether the one or more running environments are installed on the mobile terminal, and the process 403 for obtaining the one or more running environments from a cloud server and installing the one or more running environments on the mobile terminal.

According to one embodiment, during the process 401, it is determined whether the application requested depends on one or more running environments. For example, the process 401 is performed between the process 301 and the process 308 (e.g., as shown in FIG. 6). As an example, if the application depends on a running environment, the process 402 is executed, i.e., whether the running environment is installed on the mobile terminal is detected. As another example, if the application does not depend on a running environment, the process 302 is executed. In some embodiments, one or more processes between the process 301 and 308 (e.g., as shown in FIG. 6) are executed if the application does not depend on a running environment.

According to another embodiment, if the running environment is not installed on the mobile terminal the process 403 is executed. For example, the running environment is obtained from the cloud server (e.g., the cloud server 120 or any other suitable cloud server) and installed on the mobile terminal. In another example, if the running environment is installed on the mobile terminal, the process 302 is executed and no additional operations need to be performed. In yet another example, if the running environment is installed on the mobile terminal, one or more processes between the process 301 and 308 (e.g., as shown in FIG. 6) are executed. In some embodiments, the application-installation system 100 is configured to perform the method 600 as shown in FIG. 7 to ensure automatic installation and processing of the application dependent on a running environment, which further shortens the installation time.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, alhough features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for installing an application on a mobile terminal, the method comprising:
obtaining one or more first drivers based on at least information associated with identification of a first mobile terminal;
installing the first drivers on an information-processing device;
establishing a network connection between the information-processing device and the first mobile terminal based on at least information associated with the first drivers;
querying one or more local parameters of the first mobile terminal through the network connection;
obtaining an application-installation package based on at least information associated with the local parameters; and
installing an application on the first mobile terminal using the network connection based on at least information associated with the application-installation package.

2. The method of claim 1, further comprising:
detecting whether a second mobile terminal is connected to the information-processing device;
in response to the second mobile terminal being connected to the information-processing device, detecting whether one or more second drivers are installed on the second mobile terminal;
in response to the second drivers not being installed on the second mobile terminal, obtaining the second drivers based on at least information associated with identification of the second mobile terminal.

3. The method of claim 2, further comprising:
receiving a user request for application installation.

4. The method of claim 1, wherein the obtaining one or more first drivers based on at least information associated with identification of a first mobile terminal includes:
sending the identification of the first mobile terminal to a cloud server to request the first drivers; and
receiving the first drivers from the cloud server.

5. The method of claim 1, wherein the network connection includes a Transmission Control Protocol (TCP) connection.

6. The method of claim 1, further comprising:
determining whether the application depends on one or more running environments;
in response to the application depending on the one or more running environments, detecting whether the one or more running environments are installed on the mobile terminal;
in response to the one or more running environments are not installed on the mobile terminal,
obtaining the one or more running environments from a cloud server; and
installing the one or more running environments on the mobile terminal.

7. A system for installing an application on a mobile terminal the system comprising:
a driver-obtaining module configured to obtain one or more first drivers based on at least information associated with identification of a first mobile terminal;
a driver-installation module configured to install the first drivers on an information-processing device;
a network-connection module configured to establish a network connection between the information-processing device and the first mobile terminal based on at least information associated with the first drivers;
a parameter-query module configured to query one or more local parameters of the first mobile terminal through the network connection;
an application-obtaining module configured to obtain an application-installation package based on at least information associated with the local parameters; and
an application-installation module configured to install an application on the first mobile terminal using the network connection based on at least information associated with the application-installation package.

8. The system of claim 7, further comprising:
a first detection module configured to detect whether a second mobile terminal is connected to the information-processing device; and
a second detection module configured to, in response to the second mobile terminal being connected to the information-processing device, detect whether one or more second drivers are installed on the second mobile terminal;
wherein the driver-obtaining module is configured to, in response to the second drivers not being installed on the second mobile terminal, obtain the second drivers based on at least information associated with identification of the second mobile terminal.

9. The system of claim 7, further comprising:
a request-processing module configured to receive a user request for application installation and provide the user request to the first detection module.

10. The system of claim 7, wherein the driver-obtaining module is further configured to:
send the identification of the first mobile terminal to a cloud server to request the first drivers; and
receive the first drivers from the cloud server.

11. The system of claim 7, wherein the network connection includes a TCP connection.

12. The system of claim 7, further comprising:
a running-environment-processing module configured to:
determine whether the application depends on one or more running environments;
in response to the application depending on the one or more running environments, detect whether the one or more running environments are installed on the mobile terminal;
in response to the one or more running environments are not installed on the mobile terminal,
obtain the one or more running environments from a cloud server; and
install the one or more running environments on the mobile terminal.

13. The system of claim 7, further comprising:
one or more data processors; and
a computer-readable storage medium;
wherein one or more of the driver-obtaining module, the driver-installation module, the network-connection module, the parameter-query module, the application-obtaining module, and the application-installation module are stored in the storage medium and configured to be executed by the one or more data processors.

14. A non-transitory computer readable storage medium comprising programming instructions for installing an application on a mobile terminal, the programming instructions configured to cause one or more data processors to execute operations comprising:
obtaining one or more first drivers based on at least information associated with identification of a first mobile terminal;
installing the first drivers on an information-processing device;
establishing a network connection between the information-processing device and the first mobile terminal based on at least information associated with the first drivers;
querying one or more local parameters of the first mobile terminal through the network connection;
obtaining an application-installation package based on at least information associated with the local parameters; and
installing an application on the first mobile terminal using the network connection based on at least information associated with the application-installation package.
